(19) United States
(12) Patent Application Publication
(10) Pub. No.: US 2024/0179113 A1
(43) Pub. Date: May 30, 2024

(54) METHODS AND DEVICES FOR COMMUNICATION WITH MULTIMODAL COMPOSITIONS

(71) Applicants: Jian ZHAO, Waterloo (CA); Pengcheng AN, Waterloo (CA); Ziqi ZHOU, Waterloo (CA); Qing LIU, Waterloo (CA); HUAWEI TECHNOLOGIES CANADA CO., LTD., Kanata (CA)

(72) Inventors: Jian ZHAO, Waterloo (CA); Pengcheng AN, Waterloo (CN); Ziqi ZHOU, Waterloo (CA); Qing LIU, Waterloo (CA); Da-yuan HUANG, Markham (CA); Linghao DU, Richmond Hill (CA); Wei LI, Markham (CA)

(21) Appl. No.: 18/431,698

(22) Filed: Feb. 2, 2024

Related U.S. Application Data
(63) Continuation of application No. PCT/CA2022/051346, filed on Sep. 8, 2022.
(60) Provisional application No. 63/241,945, filed on Sep. 8, 2021.

(51) Int. Cl. H04L 51/10; H04L 51/08

(52) U.S. Cl. CPC H04L 51/10; H04L 51/08

(57) ABSTRACT

Methods and devices are described that enable a device to generate a message including a multimodal composition, and to output the message on a device. The multimodal composition is generated by first selecting a first element belonging to a first output modality. The multimodal composition is further generated by selecting at least one second element belonging to a second output modality to associate with the first element, the combination of the first element and the second element being the multimodal composition.

### CROSS-REFERENCE TO RELATED APPLICATIONS

The present application is a continuation of International Application No. PCT/CA2022/051346, entitled “METHODS AND DEVICES FOR COMMUNICATION WITH MULTIMODAL COMPOSITIONS”, filed Sep. 8, 2022, which claims priority from U.S. Provisional Patent No. 63/241,945, entitled “METHODS AND DEVICES FOR COMMUNICATION WITH MULTIMODAL COMPOSITIONS”, filed Sep. 8, 2021, all of which are hereby incorporated by reference in their entireties.

### TECHNICAL FIELD

The present disclosure is related to methods and devices for communication, in particularly, for generating a message including a multimodal composition, which can be communicated between two or more devices, where a multimodal composition is generated from two or more elements belonging to two or more output modalities.

### BACKGROUND

The rise of the internet, social media and text based instant messaging has driven the development of a graphic tools like emoticons and emojis as a new and useful method of communication. It can be challenging to accurately convey emotions in text-only interactions, as many other important non-textual signals necessary for human communication are lost. These non-textual signals may include the volume and emphasis of words, intonation and tone of voice, as well as non-verbal language such as gestures, facial expressions and body language.

The addition of graphic elements such as emoticons and emojis to text-based conversations have grown in popularity due to their ability to more accurately convey emotion, in a simple and accessible format. Text-based emoji prediction is now common in many applications, encouraging more users to add emojis to conversations. More recently, there is a growing trend to enhance emojis with different output modalities, to more effectively convey human emotion through the addition of animation outputs to enhance viewing of the emoji. However, existing technologies have limited capabilities with respect to providing such multimodal emojis.

Accordingly, it would be useful to provide a solution that can provide more advanced capabilities for adding multimodal outputs to messages.

### SUMMARY

Some existing instant messaging applications provide options for multimodal emojis, however these existing technologies have a drawback that the multimodal output associated with each emoji is predefined and not variable. That is, the type (and the intensity) of the multimodal output that is provided for a given emoji is fixed. As a result, the information that can be included in a communication is limited. Another drawback of some existing technologies is that, if a recommendation to include an emoji is provided, such recommendation is based only on inputted text data. The recommendation does not consider the full context of the communication. Although some existing technologies enable a user to customize or change the output associated with an emoji, the options for customization are limited (e.g., simple change in size) or requires extensive user input (e.g., requires user to record audio data, or requires navigation through multiple menus). Some existing technologies also have the drawback that an emoji included in a received message has little or no interactivity with the user at the receiving device.

The present disclosure describes examples that enable a device to generate a multimodal composition that can be added to messages (e.g., text-based communication) and transmitted among user devices. The multimodal composition is generated using two or more elements belonging to two or more output modalities, where the elements can be customized. Further, the elements that are used to generate such multimodal compositions may be recommended or ranked by a device based on a user's inputs (including both text-based and non-text based inputs), which may provide a more intuitive user experience, and reduce the amount of user interactions required to select and input a desired multimodal composition.

In various examples, the present disclosure describes methods and devices that enable a device to output (e.g., display on the device and/or transmit to another device) a message having a multimodal composition. The message, after being received at a receiving device, can generate multimodal output at the receiving device in accordance with the elements of the multimodal composition. The multimodal output associated with the multimodal composition can be defined by output parameters that are variable (e.g., not predefined and fixed for a specific multimodal composition). In some examples, a user parameter (e.g., a parameter representing a user's emotional state or representing a user's intention) can be detected from user input, which may be mapped to a particular element to be used for the multimodal composition. In some examples the user parameter may additionally or alternatively mapped to an output parameter to control the intensity (e.g., volume, frequency of vibration, intensity of color, etc.) of the particular element used for the multimodal composition. In some examples, if there is no input for an output parameter, a default value may be used for that output parameter.

In various examples, the present disclosure also describes methods and devices that enable a device to automatically generate a recommendation of an element to use for generating a multimodal composition to include in a message, based on the context of the message. Different elements that can be used to generate a multimodal composition may be ranked, based on the context of a message, and the ranked elements may be is provided as a ranked recommendation. The ranked recommendation may enable a user to more easily identify and select a suitable element to use for generating a multimodal composition.

In some examples, the present disclosure provides the technical advantage that a device is enabled to generate and output a message in which a multimodal composition in the message is customized to inputs detected by the device. The elements that are combined to generate the multimodal composition may be customized in real-time based on inputs detected by the device at the time that the message is generated. This enables the device to dynamically vary the multimodal output associated with the multimodal composition.

In some examples, the present disclosure also provides the technical advantage that a device is enabled to recommend likely element(s) to use for generating a multimodal composition to be included in a message, based on message context. This enables the device to bypass steps requiring more user input, reducing the amount of inputs and outputs that need to be processed by the device, and thus reducing the consumption of resources (e.g., battery power, processing power, memory, etc.) by the device.

In some examples, the present disclosure also provides the technical advantage that a device that receives a message including a multimodal composition is enabled to interact with the multimodal composition, such that the user receiving the message will experience a customized multimodal composition based on the user parameters (e.g., parameters representing an emotional state) of the recipient, rather than the sender.

In some example aspects, the present disclosure describes a method at a device. The method includes: obtaining, via a user interface for generating a message, a first input indicating a first element belonging to a first output modality to include in the message; obtaining, via the user interface, a second input indicating at least one second element belonging to a second output modality to associate with the first element, combining the first element and the at least one second element to generate a multimodal composition; and outputting the message including the multimodal element.

In an example of the preceding example aspect of the method, the method may include: displaying, via the user interface, one or more recommended second elements belonging to the second output modality to include in the message, the one or more recommended second elements belonging to the second output modality being ranked using a recommendation score that is computed based on relevancy to the first element.

In an example of the preceding example aspect of the method, the recommendation score may be computed based on at least one of: emotional relevancy to the first element, wherein the emotional relevancy is computed based on a distance between the first element and each of the one or more recommended second elements belonging to the second output modality in a defined emotion space; or statistical relevancy to the first element, wherein the statistical relevancy is computed based on occurrence of each of the one or more recommended second elements together with the first element in a historical message.

In an example of any of the preceding example aspects of the method, the method may include: detecting a user parameter, based on the first input, the second input or a third input; wherein the recommendation score is further computed based on relevancy to the user parameter based on a distance between each of the one or more recommended second elements and the user parameter in a defined user parameter space.

In an example of the preceding example aspect of the method, the first, second or third input representing the user parameter may be obtained by at least one of: a gesture input; a facial expression input; a text input; an audio input; or a force input.

In an example of any of the preceding example aspects of the method, the method may include: displaying, via the user interface, one or more recommended first elements to include in the message, the one or more recommended first elements being ranked using a recommendation score that is computed based on relevancy to a context of the message.

In an example of the preceding example aspect of the method, the context of the message may be a user parameter of the message, the method may further include: detecting the user parameter of the message; wherein the recommendation score is computed based on relevancy to the user parameter of the message based on a distance between each of the one or more recommended first elements and the user parameter in a defined user parameter space.

In an example of any of the preceding example aspects of the method, the context of the message may include a prior element in a messaging session, and the recommendation score may be computed based on at least one of: emotional relevancy to the prior element, wherein the emotional relevancy is computed based on a distance between the prior element and each of the one or more recommended first elements in a defined emotion space; or statistical relevancy to the prior element, wherein the statistical relevancy is computed based on occurrence of each of the one or more recommended first elements together with the prior element in a historical message.

In an example of any of the preceding example aspects of the method, the first element belonging to the first output modality and the at least one second element belonging to the second output modality may be at least two different ones of: a static graphic element; an animation element; an audio element; or a haptic element.

In an example of any of the preceding example aspects of the method, the device may be one of: a mobile communication device; a laptop device; a tablet device; a wearable device; an Internet of Things (IoT) device; or a vehicular device.

In an example of any of the preceding example aspects of the method, outputting the message may include: transmitting, to a receiving device, a communication of the message including the multimodal element.

In an example of any of the preceding example aspects of the method, transmitting the communication of the message including the multimodal composition may include transmission of a set of one or more user parameters associated with the multimodal composition, where the one or more user parameters may define how the multimodal composition causes the receiving device to generate output in at least one of the first and the second output modalities.

In an example of any of the preceding example aspects of the method, the method may include: obtaining the first input and the second input via at least one input gesture.

In some example aspects, the present disclosure describes a device. The device includes: a memory storing instructions; and a processing unit coupled to the memory; wherein the processing unit is configured to execute the instructions to cause the device to perform any of the preceding example aspects of the method.

In some example aspects, the present disclosure describes a computer readable medium storing instructions thereon. The instructions, when executed by a processing unit of an electronic device, cause the device to: perform any of the preceding example aspects of the method.

In some example aspects, the present disclosure describes a computer program. The program, when executed by a computer, cause the device to: perform any of the preceding example aspects of the method.

### BRIEF DESCRIPTION OF THE DRAWINGS

Reference will now be made, by way of example, to the accompanying drawings which show example embodiments of the present application, and in which:

FIG. 1 is a block diagram illustrating some components of an electronic device, in accordance with examples of the present disclosure;

FIG. 2 is a block diagram illustrating details of an example multimodal composition manager, in accordance with examples of the present disclosure;

FIG. 3 illustrates example elements that may be combined to generate a multimodal composition, in accordance with examples of the present disclosure;

FIG. 4 is a flowchart illustrating an example method for generating a customized multimodal composition to include in a message;

FIG. 5 illustrates an example pseudocode, which may be used to compute the recommendation score, in accordance with examples of the present disclosure;

FIG. 6 illustrates an example of how user parameters may be mapped to a 2D emotion space for selecting or recommending customizable elements, for generating a multimodal composition;

FIG. 7 illustrates an example embodiment of a user interface on a mobile communications device, in accordance with examples of the present disclosure;

FIG. 8 illustrates an example embodiment where other inputs are used in the recommendation system;

FIG. 9 illustrates an example embodiment of a touchscreen gesture sequence used to input a user parameter, in accordance with examples of the present disclosure; and

FIG. 10 illustrates an example embodiment where a user can interact with a multimodal composition in a received message.

Similar reference numerals may have been used in different figures to denote similar components.

### DETAILED DESCRIPTION

In various examples, the present disclosure describes methods and systems enabling an electronic device to generate a message including a multimodal composition. The message including the multimodal composition may be transmitted to a receiving device. The electronic device may be any mobile or stationary electronic device such as a mobile communication device (e.g., smartphone), a tablet device, a laptop device, a network-enabled vehicle (e.g., a vehicle having an electronic communication device integrated therein), a wearable device (e.g., smartwatch, smartglasses, etc.), a desktop device, an internet of things (IoT) device (e.g., smart television, smart appliance), or a smart speaker, among others. The electronic device may be any electronic device capable of generating and transmitting messages that include non-textual elements.

Although the present disclosure describes some examples in the context of instant messaging applications, it should be understood that the present disclosure may encompass other forms of electronic messages (e.g., email).

Some terminology is first introduced. A multimodal composition, in the present disclosure, is formed by a combination of at least two elements belonging to at least two output modalities. An element belonging to an output modality is any non-textual element that may be included in a message, that is supported by at least one of the output capabilities on a user device. For example, an graphic element, an animation element, an audio element, and a haptic element can belong to output modalities respectively supported by displays, speakers, and haptic actuators of a user device. In general, a multimodal composition is a combination of at least a first element belonging to a first output modality, and a second element belonging to a second output modality (different from the first output modality). In some examples, the first element may be referred to as the base element, which is enhanced by the second element. For example, the first element may be a graphic element, such as an emoji, a static virtual sticker, an animated virtual sticker, an icon, etc. The second element may be any element that can provide output in combination with the first element, for example the second element may be such as a high-resolution image, an animation, a sound effect, a haptic effect, etc. It should be understood that the first element is not necessarily limited to any particular type or types of output modalities; and similarly the second element is not necessarily limited to any particular type or types of output modalities. A multimodal output is a rendering of a multimodal composition on a user device. A multimodal output is an output that involves two or more output modalities, such as a combination of two or more of: static visual output, dynamic (or animated) visual output, audio output, and haptic output, etc.

In the present disclosure, a user parameter is a representation, for example, a numeric representation of a state or intention of a user. For example, a user parameter may be an emotion parameter that represents an emotional state (or intended emotional state) of a user. Emotion parameters may include arousal and valence parameters, which together may define a two-dimensional (2D) emotion space (e.g., as is commonly used in study of human behaviors). Other emotion parameters may be used, and the emotion space may be a higher-dimensional emotion space. Other user parameters may include an urgency parameter, a pleasantness parameter, an intensity parameter, etc. In general, a user parameter may be detected from implicit user input (e.g., an urgency or emotion parameter may be implied by the force magnitude of a user's gesture input) or explicit user input (e.g., an intensity parameter may be explicitly indicated by a user controlling a slider on a user interface).

To assist in understanding the present disclosure, some existing technologies are first discussed.

For example, some existing technologies that generate a multimodal output include: animated emojis that are enhanced with predefined sounds and/or vibrations; predefined animation options for emojis and haptic effects predefined for selected emojis; options to allow a user to change the size of an emoji; predefined animations for emojis that can be replayed when tapped; pre-generated stickers which are combinations of existing emojis; and emojis that include options for recording messages.

Some existing technologies have a drawback that the multimodal output associated with each emoji is predefined and not variable. As a result, the information that can be included in a message is limited. Another drawback of some existing technologies is that, if a recommendation to include an emoji is provided, such recommendation is based only on inputted text data. The recommendation does not consider the full context of the message, which (in some embodiments disclosed herein) may include input from other elements or other detected user inputs to indicate emotion or other user parameter, in addition to the textual context. Although some existing technologies enable a user to customize or change the output associated with an emoji, the options for customization are limited (e.g., simple change in size) or requires extensive user input (e.g., requires user to record audio data, or requires navigation through multiple menus). Some existing technologies also have the drawback that an emoji included in a received message has little or no interactivity with the user at the receiving device.

The present disclosure describes examples that may help to address some or all of the above drawbacks of existing technologies.

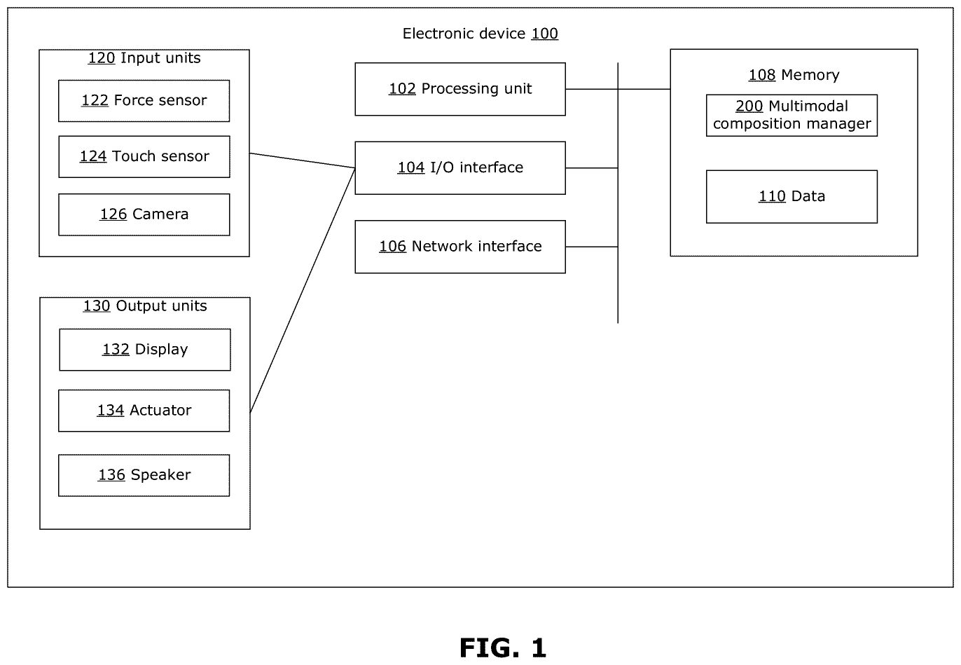

FIG. 1 is a block diagram showing some components of an electronic device 100, in which examples of the present disclosure may be implemented. Although FIG. 1 shows a single instance of each component, there may be multiple instances of each component shown.

The electronic device 100 includes at least one processing unit 102, such as a processor, a microprocessor, an application-specific integrated circuit (ASIC), a field-programmable gate array (FPGA), a dedicated logic circuitry, a dedicated artificial intelligence processor unit, or combinations thereof. The electronic device 100 also includes at least one input/output (I/O) interface 104, which interfaces with input units 120 (such as a force sensor 122, a touch sensor 124 and a camera 126) and output units 130 (such as a display 132, an actuator 134 and a speaker 136). The electronic device 100 may include or may couple to other input units (e.g., mechanical buttons, microphone, keyboard, etc.) and other output units (e.g., lights, etc.).

The force sensor 122 generates force data in response to detecting an applied force (e.g., the force applied by a user gripping the electronic device 100). The value of the generated force data may be proportional to the magnitude of the applied force, for example. The touch sensor 124 generates touch data in response to detecting a touch input (e.g., a static touch or a dynamic touch (also referred to as a gesture)). The camera 126 generates image data (e.g., static image data or video data comprising multiple frames).

The I/O interface 104 may buffer the data generated by the input units 120 and provide the data to the processing unit 102 to be processed in real-time or near real-time (e.g., within 10 ms, or within 100 ms). The I/O interface 104 may perform preprocessing operations on the input data, for example normalization, filtering, denoising, etc., prior to providing the data to the processing unit 102.

The I/O interface 104 may also translate control signals from the processing unit 102 into output signals suitable to each respective output unit 130. The display 132 may receive signals to provide a visual output to a user. In some examples, the display 132 may be a touch-sensitive display (also referred to as a touchscreen) in which the touch sensor 124 is integrated. A touch-sensitive display may both provide visual output and receive touch input. The actuator 134 may receive signals to provide haptic output (e.g., vibrational output, which may have a defined vibration frequency and/or vibration magnitude). The speaker 136 may receive signals to provide an audio output to a user.

The electronic device 100 includes at least one network interface 106 for wired or wireless communication with a network (e.g., an intranet, the Internet, a P2P network, a WAN and/or a LAN) or other node. The network interface 106 may include wired links (e.g., Ethernet cable) and/or wireless links (e.g., one or more antennas) for intra-network and/or inter-network communications. The electronic device 100 may transmit and receive communications with another electronic device via the network interface 106.

The electronic device 100 includes at least one memory 108, which may include a volatile or non-volatile memory (e.g., a flash memory, a random access memory (RAM), and/or a read-only memory (ROM)). The non-transitory memory 108 may store instructions for execution by the processing unit 102, such as to carry out examples described in the present disclosure. For example, the memory 108 may include instructions for executing a multimodal composition manager 200 and/or for performing methods and functions disclosed herein.

The memory 108 may include other software instructions, such as for implementing an operating system and other applications/functions. The memory 108 may also include data 110, such as a record of previous communications transmitted or received by the electronic device 100.

In some examples, the electronic device 100 may also include one or more electronic storage units (not shown), such as a solid state drive, a hard disk drive, a magnetic disk drive and/or an optical disk drive. In some examples, one or more data sets and/or modules may be provided by an external memory (e.g., an external drive in wired or wireless communication with the electronic device 100) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage. The components of the electronic device 100 may communicate with each other via a bus, for example.

The electronic device 100 may be a transmitting device, which transmits a communication of a message including a multimodal composition. The electronic device 100 may also be a receiving device, which receives the communication of the message including the multimodal composition.

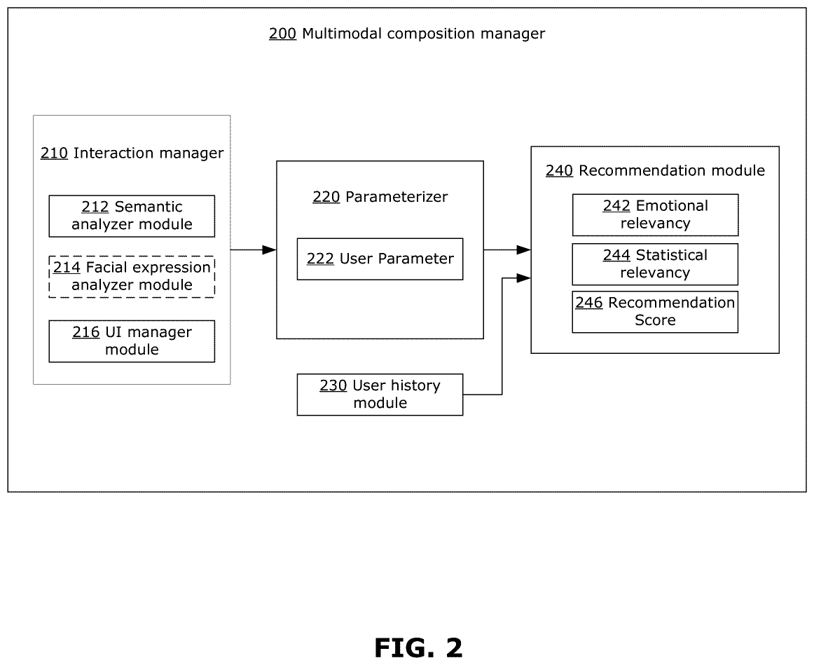

FIG. 2 is a block diagram illustrating details of an example multimodal composition manager 200 that may be used by the electronic device 100 to generate a multimodal composition to include in a message, accordance with examples of the present disclosure.

In some examples, the multimodal composition manager 200 receives user inputs for generating a message including a multimodal composition, maps various inputs to output parameters and recommends one or more elements to be used for generating the multimodal composition, these one or more recommended elements being ranked using a recommendation score 246.

In some examples, the multimodal composition manager 200 accepts a user input or user inputs indicating the selection of a first element belonging to a first output modality through the interaction manager 210. User inputs may include text inputs, audio inputs, chat history, holding gestures, facial expression inputs, or any number of inputs captured through interactions with a user interface, including touch inputs, gesture inputs or force inputs. Inputs are processed through the interaction manager 210. Specifically, text and audio inputs may be processed by the semantic analyzer module 212, facial expression inputs captured via a camera 126 may be processed by a facial expression analyzer module 214 and touch inputs, gesture inputs and force inputs may be processed by a UI manager module 216. These inputs will feed into the parameterizer 220 and inform the computation of the recommendation score 246. For example, a user parameter (e.g., emotion parameter, urgency parameter or other parameter, such as another parameter relevant to a user's intention) may be detected by the parameterizer from the user input. The user parameter may be mapped to an output parameter (e.g., volume, magnitude, intensity, etc.) for controlling the output of at least one modality of the multimodal composition.

In some examples, the parameterizer 220 uses parameterization to generate a user parameter 222, which is a numeric representation of an intention of a user. For example, a user parameter may be an emotion parameter, which may include arousal and valence parameters, which together may define a two-dimensional (2D) emotion space (e.g., as is commonly used in study of human behaviors). Other user parameters may be used, and the user parameter space may be a higher-dimensional space. In generate, the parameterizer 220 may generate one or more user parameters (including an emotion parameter) which is a numeric representation in a user parameter space, which may represent a user's intention that the user desires to be conveyed by the multimodal composition. In some examples, a user parameter may also be referred to as an expression parameter, and multiple expression parameters may together define an expression space.

An element that may be selected to generate the multimodal composition may be associated with one or more user parameters. For example, using empirical testing (e.g., by asking the user to assign emotions or expressions to different elements) and/or using statistical data collected from multiple users (e.g., by evaluating how different users select elements to use in different emotional or expression contexts), each element may be mapped to a respective location in the user parameter space. The location of an element in the user parameter space may, for example, be represented as numerical values for each user parameter 222, where each user parameter 222 is a respective axis in the user parameter space. In another example, the output provided by an element may be controlled by an output parameter. The user parameter 222 may be mapped to a particular value of the output parameter, such that the user parameter 222 may affect the output parameter in a continuous manner. For example, if the user parameter 222 has a low numerical value (e.g., low urgency value), the output parameter may similarly have a low value (e.g., low volume). Other techniques for mapping elements in the user parameter space and/or to numerical values of user parameters may be used.

The user parameter 222 of a message may represent the context of the message. The context of the message may reflect the user's emotional state or intension and may encompass input from a prior element (e.g., prior graphic element) in the message history, as well as textual context of a message, as well as context with respect to other graphics in the message and/or with respect to other detected user inputs indicating the user parameter 222 in the defined user parameter space. The context of the message feeds into the recommendation module 200 and contributes to the computation of rankings for recommended elements that are presented to a user in a display.

In some examples, the user history module 230 captures the accumulated user history of messages transmitted and received by the user. The user history may be analyzed to determine occurrences of each element together with other elements in any historical message. The information contained within the user history module 230 contains the data required for the computation of statistical relevancy 244, and where this prior knowledge of user history is reflected in the recommendation score 246.

In some examples, in response to a user input indicating the selection of a first element belonging to a first output modality, the recommendation module 240 recommends other elements belonging to a second output modality to associate with the first element, for generating the multimodal composition. The recommendation module 240 ranks one or more other elements using a recommendation score 246. The recommendation score 246 may be computed based on relevancy to the selected first element. Relevancy to the selected first element may include emotional relevancy 242. Emotional relevancy may refer to the similarity in emotions conveyed. Various techniques may be used to compute emotional relevancy to the selected first element. For example, emotional relevancy may be computed based on a distance between the selected first element and each of the one or more recommended other elements in a defined emotion space (e.g., the 2D arousal-valence emotion space). In another example, relevancy to the selected first element may include statistical relevancy 244. Statistical relevancy may refer to the likelihood that two elements are found together, are combined together in a multimodal composition, or are found in close proximity in messages. Various techniques may be used to compute statistical relevancy. For example, the statistical relevancy may be computed based on occurrence of each of the one or more recommended other elements together with the selected first element in any historical message (e.g., a previous message in the current messaging session, a previous message in the chat histories of the user, etc.).

In some examples, the recommendation score 246 may be computed as a weighted combination of statistical relevancy 244 and emotional relevancy 242. The statistical relevancy 244 may be computed based on Term Frequency-Inverse Document Frequency (TF-IDF). The emotional relevancy may be computed based on Euclidian Distance (ED) within the defined emotion space. For example, the recommendation score (RS) may be defined according to the following equation:

$$R S ( e , m ) = α \cdot TF - IDF ( e , m ) + β \cdot \frac{1}{E D ( e , m )}$$

where e denotes the selected first element, m denotes the other element belonging to a second output modality, and α and β are tunable weights that weight the relative contribution of the statistical relevancy and the emotional relevancy, respectively, to computation of the recommendation score 246 (e.g., α=0.4 and β=0.6). In some examples, the recommendation score 246 may be computed using only the statistical relevancy (e.g., by setting β=0), or may be computed using only the emotional relevancy (e.g., by setting α=0).

In an example, emotional relevancy 242 to the selected first element is computed based on the Euclidian distance (ED) between the selected first element (e) and of the one or more recommended other elements (m) in a defined emotion space (e.g. valence-arousal space), according to the following equation:

ED(e,m)={square root over ((v(e)−v(m))²+(a(e)−a(m))²)}

where v(e) is a numerical value representing the valence of element e and a(e) is a numerical value representing the arousal of element e.

In an example, statistical relevancy 244 to the selected first element is computed based on occurrence of each of the one or more recommended other elements together with the selected first element in any historical message, according to the following equation:

TF-IDF(e,m)=TF(e,m)·(IDF(e,m)+1)

where TF(e, m) is the frequency of element e, and is represented by the following equation:

$$T F ( e , m ) = \frac{f ( e , m )}{f ( e , M )}$$

where ƒ(e, m) is the frequency between the selected element e and the candidate element m, and where ƒ(e, M)=Σ_{m∈M}ƒ(e, m), where M is the set of all candidate elements. And where IDF (e, m) measures how much information the element provides, and is represented by the following equation:

$$IDF ( e , m ) = log ( \frac{n}{C ( m , E ) + 1} )$$

where C(m, E)=Σ_{e∈E}N(e, m), where E is the set of all selected elements, and where

$$N ( e , m ) = \{ \begin{matrix}1 , f ( e , m ) \geq 1 \\ 0 , else\end{matrix}$$

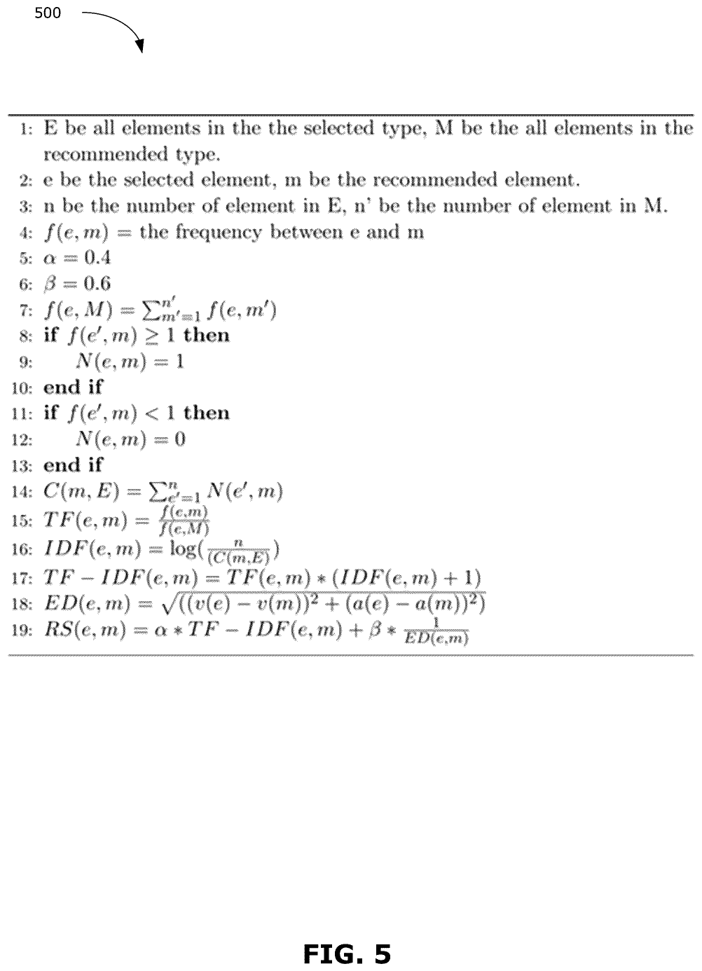

FIG. 5 illustrates an example pseudocode 500, which may be used to compute the recommendation score 246, as described above.

In some examples, in response to a user input indicating the selection of a first element belonging to a first output modality to use for generating the multimodal composition, the multimodal composition manager 200 may detect that input represents a user parameter 222. The recommendation score 246 may be further computed based on relevancy to the user parameter 222. Various techniques may be used to compute relevancy to the user parameter 222. For example, emotional relevancy may be computed based on a distance between each of the one or more recommended other elements and the user parameter 222 in the defined user parameter space (e.g., by computing the Euclidean distance to the user parameter 222 in the 2D arousal-valence emotion space, similar to that described above). The relevancy to the user parameter 222 may be incorporated in the computation of the recommendation score 246 described above (e.g., as an additional weighted term), or may replace the emotional relevancy term, for example. The detected input representing the user parameter 222 may be at least one of a gesture input, a facial expression input, a text input, an audio input or a force input, or combinations thereof.

Although the preceding examples describe the multimodal composition manager 200 performing operations to compute a recommendation score 246 to rank different elements that may be selected to generate the multimodal composition, in other examples the multimodal composition manager 200 may instead rank (or recommend) one or more multimodal compositions (instead of separate elements). For example, based on the recommendation score 246 computed between different elements belonging to different modalities, the multimodal composition manager 200 may automatically generate a recommended multimodal composition using the highest ranked elements from each output modality. For example, the multimodal composition manager 200 may automatically identify the highest ranked graphic element (belonging to a static visual output modality), the highest ranked animation element (belonging to a dynamic visual output modality), the highest ranked audio element (belonging to an audio output modality) and the highest ranked haptic element (belonging to a haptic output modality), and generate the recommended multimodal composition as a combination of these identified highest ranked elements. Notably, the different output modalities that may be combined to result in the recommended multimodal composition are not predefined (as in some existing technologies), but rather may be identified dynamically (i.e., on-the-fly or in real-time based on detected inputs and message context). In some examples, the multimodal composition manager 200 may rank (or recommend) an element belonging to a first output modality and may automatically select another element belonging to a second output modality based on a user selecting a first element. For example, the multimodal composition manager 200 may enable a user to select (from a recommended and/or ranked list) a graphic element and an animation element to use for the multimodal composition, and the multimodal composition manager 200 may then automatically select (based on computation of the recommendation score 246 relevant to the user selected graphic and animation elements) an audio element and a haptic element for the multimodal composition.

The recommended multimodal composition may be displayed in the user interface and may be selected to add to a message. In this way, the multimodal composition manager 200 may enable more convenience and time effective identification and selection of a multimodal composition to add to a message, while at the same time allowing for a range of different multimodal outputs.

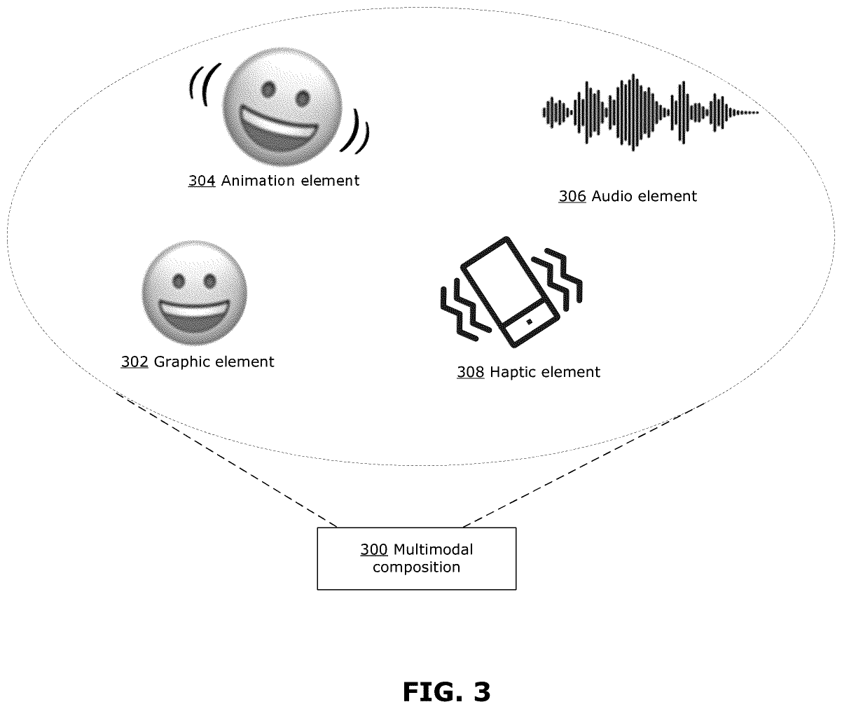

FIG. 3 illustrates example elements belonging to different output modalities that may be combined to generate a multimodal composition 300, in accordance with examples of the present disclosure. As will be discussed further below, the multimodal composition 300 may be generated by the multimodal composition manager 200, in response to input (e.g., via a user interface provided by the multimodal composition manager 200) at a transmitting device.

The multimodal composition 300, in the present disclosure, is a combination of two or more elements belonging to different output modalities. For example, as shown in FIG. 3, the multimodal composition 300 may be a combination of a graphic element 302, an animation element 304, an audio element 300 and/or a haptic 308.

In some examples, after a first element (e.g., a graphic element 302) is selected, based on a recommendation score 246, one or more other elements, belonging to a second output modality, may be ranked or otherwise recommend and displayed in the user interface. An input indicating selection of at least one other element belonging to a second output modality is received (e.g., via the user interface), such as an animation element 304, an audio element 300 or a haptic element 308. The combination of the selected first element and the selected second element (or multiple other elements) results in a multimodal composition 300. The multimodal composition 300 may be inserted into a message (e.g., instance message) that is outputted for display and/or communicated to another receiving device.

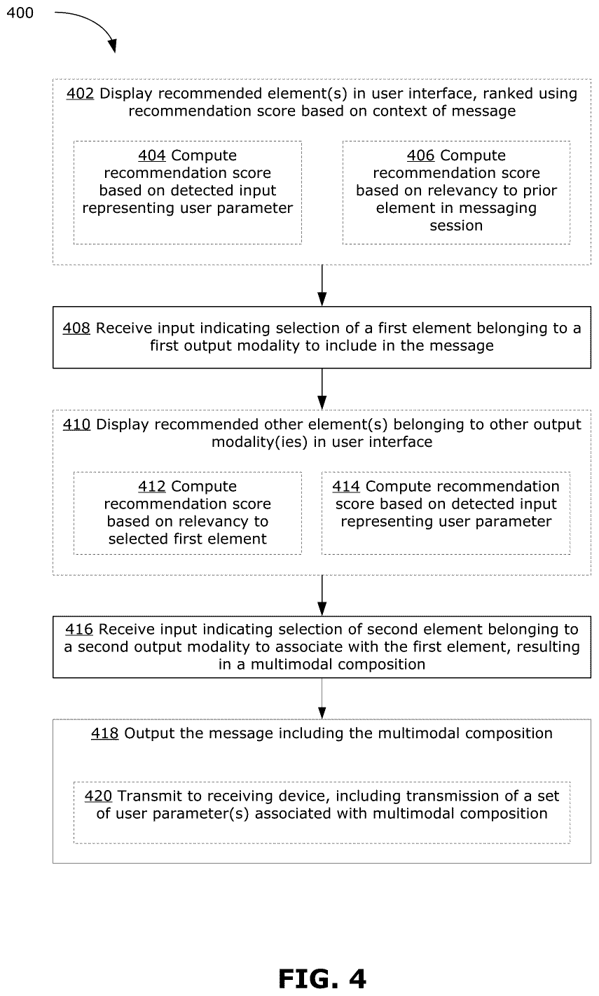

FIG. 4 is a flowchart illustrating an example method 400 for generating a customized multimodal composition that may be included in a message, which may be for transmission to a receiving device. The method 400 may be performed by a device, for example a transmitting device (e.g., by the processing unit of the transmitting device executing instructions stored in the memory of the transmitting device), for example using the multimodal composition manager 200.

The method 400 may be performed when a user interface for generating (e.g., composing) a message is opened (e.g., displayed) on the device. For example, the method 400 may be performed when a user of the device is using the user interface (which may be provided by the multimodal composition manager 200) to compose a message such as an instant message, which may be transmitted to another user (or multiple other users) at a receiving device (or multiple receiving devices).

Optionally, at 402, one or more recommended elements belonging to a first output modality (e.g., belonging to a static visual output modality) may be displayed via the user interface. Recommended element(s) may be ranked using a recommendation score 246 that is computed based on relevancy to a context of the message (e.g., a context of the message being composed, within the messaging session). The context of the message may be, for example, a user parameter 222 of the message (which may be detected using input from the user, for example using optional step 404) and/or one (or more) prior elements in the messaging session (for example, using optional step 406). In some examples, the context of the message may additionally or alternatively be the textual context of prior text data in the messaging session.

For example, at optional step 404, a user parameter 222 of the message may be detected by detecting input (e.g., from the user of the transmitting device) representing the user parameter 222. Detected inputs may include force input (e.g., force or torque applied to the device which may be detected by force sensors), facial expression input (e.g., expression of a user may be captured by a camera of the device), gesture input (e.g., a tap, touch, hold or swipe applied to the display by a user's hand, a stylus or a mouse may be detected by a touchscreen or monitor of the device), text input (e.g., text inputted by the user) and/or verbal input (e.g., captured by a microphone of the device and converted using speech-to-text conversion algorithm). The detected input may be labeled with a user parameter 222 (e.g., a numerical value for arousal, a numerical value for valence, a numerical value for urgency, a numerical value for pleasantness and/or a numerical value for intensity, etc.) using the parameterizer 220, for example. The recommendation score 246 may then be computed based on relevancy to the user parameter 222 of the message based on a distance between each graphic element and the user parameter 222 in the defined user parameter space (e.g., by calculating a Euclidean distance, as described above).

In another example, at optional step 406, the context of the message may be a prior element (which may be a multimodal composition or a conventional textual or non-textual element) in the messaging session. The recommendation score 246 may be computed based on emotional relevancy and/or statistical relevancy to the prior element, for example. Emotional relevancy and statistical relevancy may be computed using TF-IDF and/or Euclidean distance, as described above.

Based on the recommendation score 246, selectable elements may be ranked and positioned relative to their respective ranking (e.g., highest ranked graphic elements may be positioned most prominently or highest in a list) in the user interface.

Following optional step 402 (whether performed by using optional step 404, optional step 406, both, or some other technique), the method 400 proceeds to step 408.

At 408, input indication selection of a first element is received via the user interface. The selected first element belongs to a first output modality (e.g., static visual output modality, audio output modality, haptic output modality, etc.). For example, the input may be a touch input to select a static emoji or static sticker to insert in a message.

Optionally, at 410, one or more recommended other elements (e.g., belonging to other output modalities different from the output modality of the selected first element), which may be combined with the first element to generate a multimodal composition, may be displayed via the user interface. Recommended other element(s) may be ranked using a recommendation score 246 that is computed based on relevancy to the selected first element (e.g., using optional step 412) and/or based on relevancy to a user parameter 222 represented by detected input (e.g., using optional step 414).

For example, at optional step 412, relevancy to the selected first element may include emotional relevancy to the selected first element. The emotional relevancy may be computed based on a distance between the selected first element and each other possible element in a defined emotion space (e.g., the Euclidean distance in the arousal-valence emotion space, as described above).

In another example, at optional step 412, relevancy to the selected first element may additionally or alternatively include statistical relevancy to the selected first element may be computed based on occurrence of each other element together with the selected first element in any historical message (e.g., in the message history stored in the memory of the transmitted device). For example, the statistical relevancy may be computed using TF-IDF as described above.

In some examples, at optional step 414, input representing a user parameter 222 may be detected as force input, facial expression input, gesture input, text input and/or verbal input as described above with respect to optional step 404. The detected input may be labeled with a user parameter 222 (e.g., a numerical value for arousal, a numerical value for valence, a numerical value for urgency, a numerical value for pleasantness and/or a numerical value for intensity, etc.) using the parameterizer 220, for example. The recommendation score 246 may then be computed based on relevancy to the user parameter 222 of the message based on a distance between each possible other element and the user parameter 222 in the defined emotion space (e.g., by calculating a Euclidean distance, as described above).

Based on the recommendation score 246, selectable other elements (belonging to one or more other output modalities) may be ranked and positioned relative to their respective ranking (e.g., highest ranked elements may be positioned most prominently or highest in a list) in the user interface.

As previously discussed, in some examples the highest ranked other elements may be automatically identified and selected to be combined with the selected first element, to generate a recommended multimodal composition which may be selectable in the user interface.

Following optional step 410 (whether performed by using optional step 412, optional step 414, both, or some other technique), the method 400 proceeds to step 416.

At 416, input indicating selection of a second element belonging to a second output modality (different from the output modality of the first element selected at step 408) is received via the user interface. The selected second element is associated with the first element, and the combination of the selected first element and the selected second element is the multimodal composition, which may be included in the message.

At 418, the message, including the multimodal composition, is outputted by the device. For example, the message including the multimodal composition may be outputted for display on the device. In another example, the message may be outputted for transmission to a receiving device.

Optionally, at 420, transmission of the message to a receiving device includes transmission of a set of one or more user parameters 222 associated with the multimodal composition. The set of user parameter(s) may be used by the receiving device to determine how to generate multimodal output (e.g., audio output, haptic output and/or dynamic visual output), based on how user parameter(s) are interpreted by the receiving device. For example, the set of user parameter(s) associated with the multimodal element may include the user parameter(s) represented by detected input (e.g., at optional step 404 or optional step 414). In another example, the set of user parameter(s) associated with the multimodal element may include the user parameter(s) associated with the selected first element (e.g., based on the position of the first element in the defined emotion space).

In some examples the method 400 may be iterative, and the number of elements to be customized for the multimodal composition may be greater than two. Different output modalities to customize may be ranked by importance, where the modalities of higher importance (e.g., static and dynamic visual output modalities) may be customized by a user interaction (e.g. via a user interface) and the output modalities of lower importance (e.g., haptic output modality) may be customized automatically by the multimodal composition manager 200.

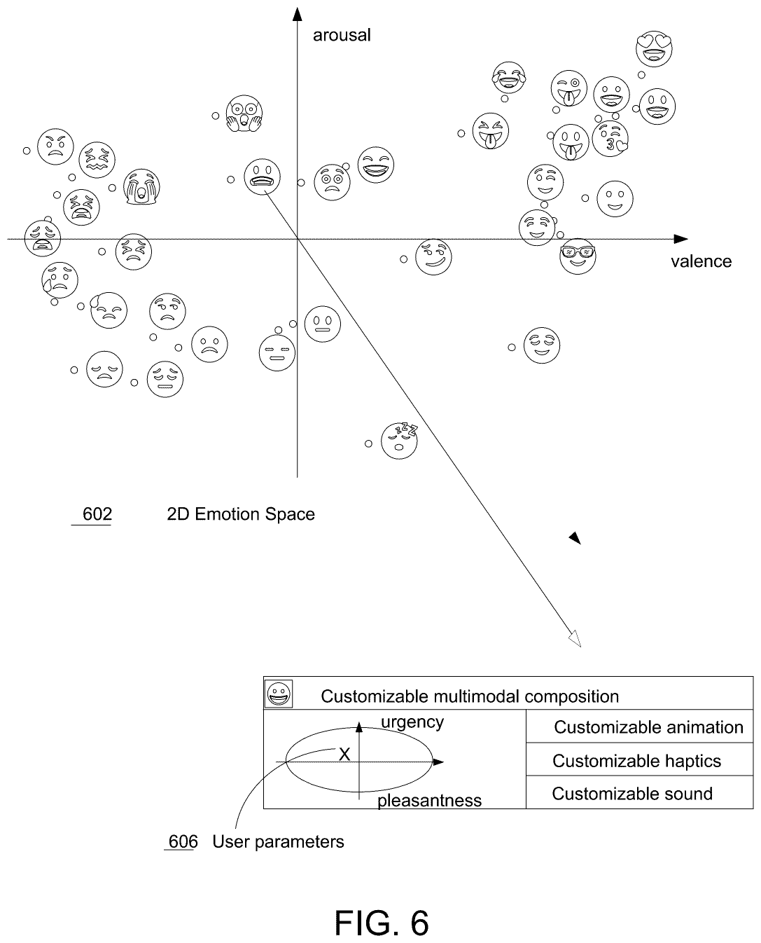

FIG. 6 illustrates an example 2D emotion space 602, which may be mapped to user parameter 606, in order to recommend or rank the elements for generating a multimodal composition. In some examples, a 2D emotion space 602 (e.g. Arousal-Valence space, Urgency-Pleasantness, or others) may be used to map the emotional properties of static graphic elements. The existing technology maps static emojis in a one-to-one correspondence to pre-defined animations, pre-defined haptics or pre-defined sounds. In the present disclosure, a parameterized approach is used instead, to enable different types of output modalities to be customized, for example based on detected user parameter 606 (which may be mapped to the emotion space 602 in order to identify the most appropriate element to select for the multimodal composition).

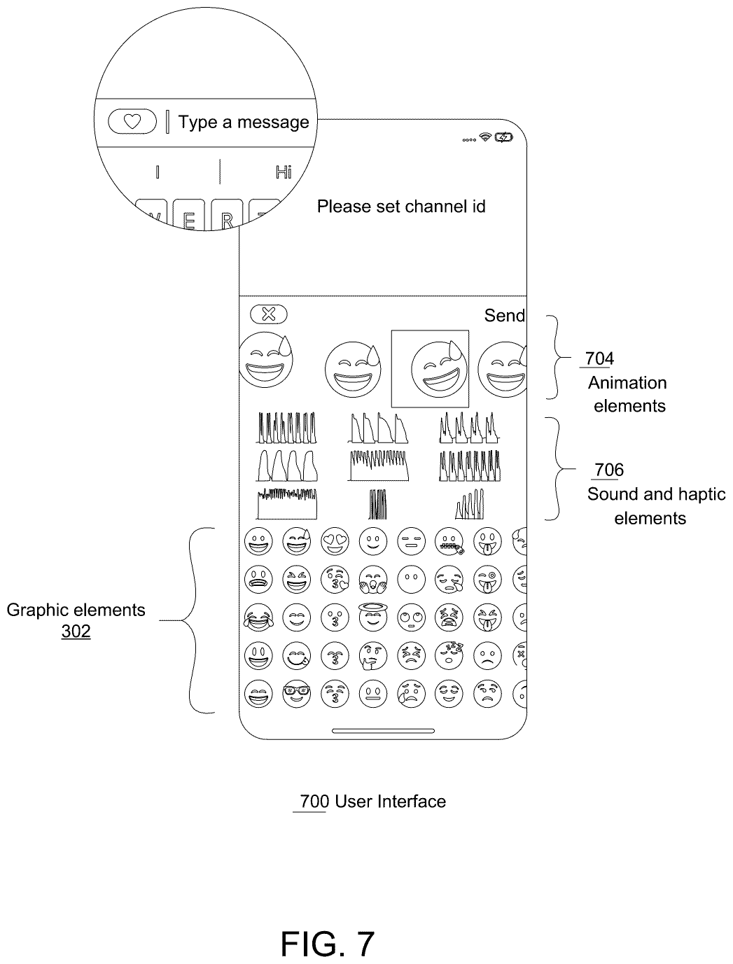

FIG. 7 illustrates an example embodiment of a user interface for generating a message, which may be displayed on an electronic device (e.g., the electronic device 100 of FIG. 1), in accordance with examples of the present disclosure.

In one example embodiment, a user interface 700 for generating a message including a multimodal composition is presented on a transmitting device, such as a mobile communications device or other electronic device. The user interface 700 may include a display of graphic elements 302 that provides to a user a visual presentation of selectable graphic elements (e.g. static emoticons) to include in the message. The presentation of selectable graphic elements 302 in the user interface 700 may be based on a ranking, for example using a recommendation score 246 as described above, where the recommendation score 246 may be computed based on relevancy to a context of the message. Graphic elements that have higher recommendation scores 246 are predicted to be more likely chosen by the user and may be positioned more dominantly (e.g., displayed higher in a list) in the display of graphic elements 302. The presentation of selectable graphic elements 302 within the user interface 700 may be dynamically updated based on the recommendation score 246, such that as the context of the message changes (e.g., as inputs representing different user parameters 222 are detected, or as newer messages are received in the conversation), the positioning of the graphic elements 302 may change.

In the preceding example embodiment, a user interface 700 for generating a message including a multimodal composition 300 may also include a display of animation elements 704, audio and haptic elements 706 to use for generating the multimodal composition. The presentation of selectable other elements in the user interface 700 may also be based on a ranking, for example using a recommendation score 246 as described above, where the recommendation score 246 that is computed based on relevancy to the a first selected element. Other elements that have higher recommendation scores 246 are predicted to be more relevant to the selected first element and may be positioned more dominantly (e.g., displayed first in a list) in the user interface 700. The presentation of selectable other elements within the user interface 700 may be dynamically updated based on the recommendation score 246, such that as the selected first element changes, the positioning of the other elements may change.

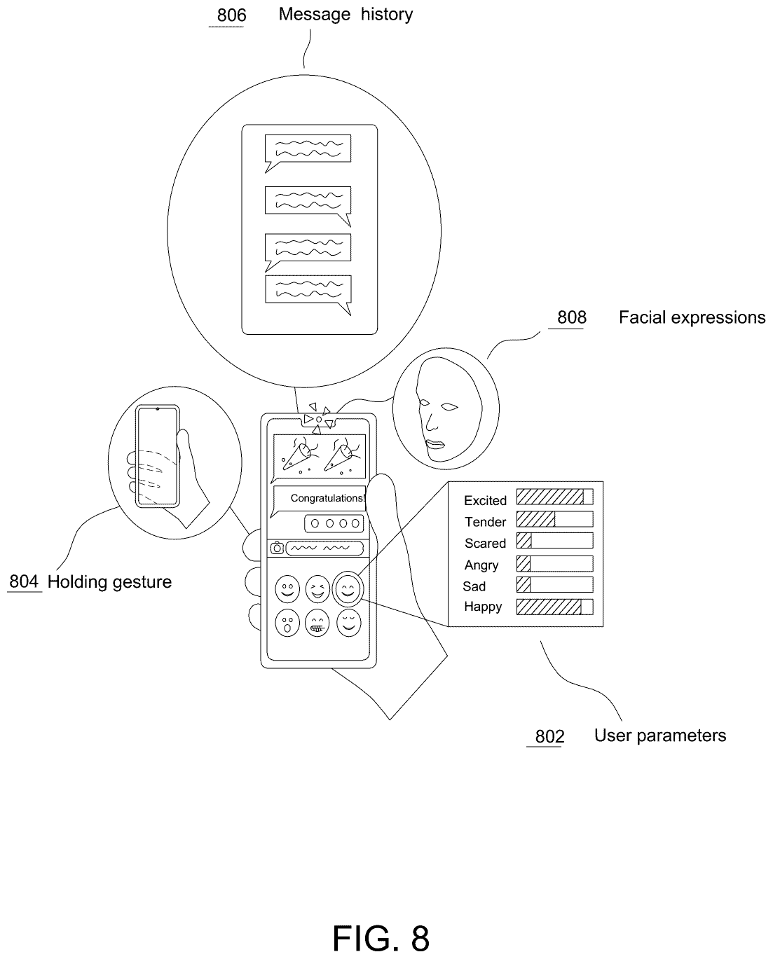

FIG. 8 illustrates an example embodiment where other inputs may be used in the recommendation system. In addition to using a tap gesture to select a first element, other inputs reflecting the emotional state, intended expression or other parameter of the user may be obtained to generate user parameters 802. The user parameters 802 may be used to generate the multimodal composition, as described above (e.g., to recommend or rank elements, or to control output parameters). Some possible user inputs that may be used to detect user parameter 802 include: holding gestures 804, message history 806 and facial expressions 808.

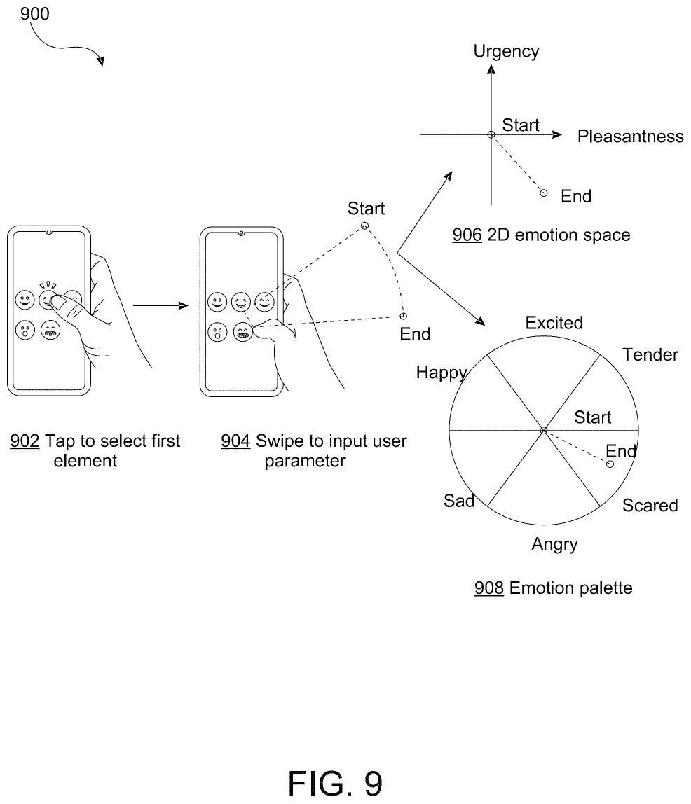

FIG. 9 illustrates an example embodiment of a touchscreen gesture sequence, which may be detected as input representing a user parameter, in accordance with examples of the present disclosure. In the example embodiment shown in FIG. 9, a touchscreen gesture sequence 900, illustrated by steps 902-904, may be applied on a touchscreen display, which may be detected as representing a user parameter 222. The sequence may be initiated at step 902 by a touch input (e.g., a tap) at a graphic element 302 displayed in the user interface, to select the graphic element. At step 904 the user may perform a swipe gesture in which a user's finger traverses from a starting point to an end point along the touchscreen display, and where an end point is achieved when the user's finger is removed from the touchscreen. Various parameters may be extracted to describe the swipe gesture including the start and end coordinates, displacement direction, displacement pattern, displacement curvature, displacement length, swipe duration, force exerted on the display, among others. The parameters of the gesture may be superposed on an emotion space such as a 2D emotion space 906 or emotion palette 908 (which may be another form of the defined emotion space, where emotion parameters are represented as categories rather than axes), whereby the gesture parameters are used to identify a user parameter 222. The user parameter 222 may then be used to map to output parameters for generating a multimodal composition.

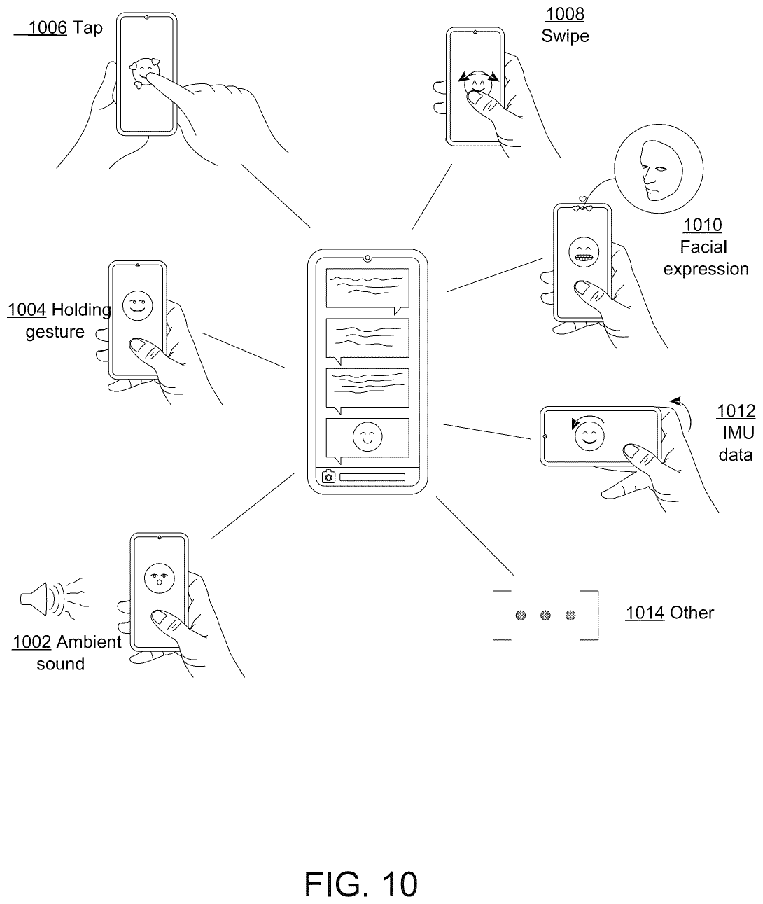

FIG. 10 illustrates an example embodiment where a user can interact with a multimodal composition in a received message. On an electronic communications device such as a tablet or smartphone, a user may interact with multimodal compositions in a received message by incorporating various input sources that may reflect the current emotional state of the user. For example, inputs may include: ambient sound 1002, holding gestures 1004, tap gestures 1006, swipe gestures 1008, facial expressions 1010, inertial measurement unit (IMU) data 1012 or other inputs 1014. These inputs may be detected as user parameters, which may be mapped to output parameters to control the multimodal output provided to the user.

In another example embodiment, a recipient of a message having a multimodal composition may interact with the multimodal composition on the receiving device, using the available input units and output units on the receiving device. For example, on an electronic communications device, after receiving a message having a multimodal composition, may initiate a sound or haptic vibration associated with the received multimodal composition. In another example, on an electronic communications device, the recipient of the message having a multimodal composition may interact with the multimodal composition using the multimodal composition manager 200 on the receiving device. Inputs detected at the receiving device such as ambient sound, a holding gesture, tap gesture, swipe gesture, facial expression, inertial measurement unit (IMU) data, etc. may be used to detect a user parameter 222 representative of the recipient's emotional state or other user intention. The recommendation module 240 may then compute a recommendation score 246 to customize the multimodal output on the receiving device. For example, animation, sound or haptic outputs associated with the multimodal composition may be customized to reflect the emotional state of the recipient rather than the sender. In one example, a user receives a multimodal composition on a device, which comprises a graphic element (e.g. “grinning face”) combined with an animation element and an audio element, where the multimodal composition is associated with a user parameter 222 (e.g. high degree of valence and high degree of arousal). The recipient proceeds to shake the device and the motion is captured by the IMU sensor on the recipient's device. The multimodal composition incorporates the input from the IMU sensor and displays a multimodal output including associated joyful animation corresponding to the shaking motion on the recipient's device, and sound and haptics that are synchronized with the shaking motion on the recipient's device. In another example, a user receives a multimodal composition on a device which comprises a graphic element (e.g. “face with tears of joy”) combined with an animation element, an audio element and a haptic element, where the multimodal composition is associated with a user parameter 222 (e.g. high degree of urgency and low degree of pleasantness). The recipient proceeds to continuously tap the device and the motion is captured by a touchscreen display or force sensing panel on the recipient's device. The multimodal composition incorporates the input from the tapping gesture and displays a multimodal output representing sadness and embarrassment, including an animation with tears falling with each tap gesture, and depressing sound and haptics that are synchronized with each teardrop.

Although some examples have been described in the context of a handheld electronic device (e.g., a smartphone), it should be understood that examples of the present disclosure may be implemented using other electronic devices, such as electronic wearable devices including smart watches or smart glasses. In an example embodiment, the multimodal composition manager 200 may be implemented in the wearable device and may perform operations to generate a message including a multimodal composition (e.g., including recommending elements to be included in the message) as described above. User inputs on the wearable device may include text inputs, audio inputs, chat history, holding gestures, facial expression inputs, or any number of inputs captured through interactions with a user interface, including touch inputs, gesture inputs or force inputs.

For example, touch inputs and gesture inputs may be applied to touch sensitive surfaces on wearable devices, such as a smart watch touchscreen display, or other touch sensitive surfaces such as on the crown on a smart watch. Inputs may also include inputs that are specific to the wearable device, for example smart watches may include health related sensors as inputs, for measuring heart rate, oxygen saturation, and stress level. Smart glasses may include touch sensitive regions on their frames as well as eye trackers, and may overlay information (such as text, images, or augmented reality (AR) overlays) in the viewports as outputs.

In another example embodiment, devices with a dedicated physical user interface such as a vehicle cabin and home appliances may have the multimodal composition manager 200 implemented within the device to perform operations to generate a message including a multimodal composition (e.g., including recommending elements to be included in the message) as described above. Inputs for these devices may include text inputs, audio inputs, chat history, or any number of inputs captured through interactions with a user interface, including touch inputs, gesture inputs or force inputs. Outputs for these devices may include a static visual output, dynamic (or animated) visual output, audio output and haptic output.

For example, touch inputs may be applied to physical knobs and buttons (e.g. on steering wheel, vehicle console, smart refrigerator, television etc.). Touch inputs and gesture inputs may also be applied to touch sensitive surfaces in vehicles or on appliances, such as a vehicle console display or a smart refrigerator display. Gesture sequences may be applied to a multimedia switch knob that provides a touch region, rotary inputs, and directional buttons. User interfaces may be adapted to fit in head-up displays, or within dashboard displays. Inputs may also include inputs that are specific to the device, for example, sensors to monitor aspects of the device performance (e.g. sensors to monitor driving behavior) Vehicles may include force feedback on the steering wheel, haptic modules embedded within seats or other locations in a vehicle cabin, various tuning profiles and climate controls as outputs. Users may also interact with the multimodal output in new ways, for example via coordination among multiple haptic modules.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable an electronic device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A method at a device, comprising:
obtaining, via a user interface for generating a message, a first input indicating a first element belonging to a first output modality to include in the message;
obtaining, via the user interface, a second input indicating at least one second element belonging to a second output modality to associate with the first element,
combining the first element and the at least one second element to generate a multimodal composition; and
outputting the message including the multimodal element.

2. The method of claim 1, further comprising:
displaying, via the user interface, one or more recommended second elements belonging to the second output modality to include in the message, the one or more recommended second elements belonging to the second output modality being ranked using a recommendation score that is computed based on relevancy to the first element.

3. The method of claim 2, wherein the recommendation score is computed based on at least one of:
emotional relevancy to the first element, wherein the emotional relevancy is computed based on a distance between the first element and each of the one or more recommended second elements belonging to the second output modality in a defined emotion space; or
statistical relevancy to the first element, wherein the statistical relevancy is computed based on occurrence of each of the one or more recommended second elements together with the first element in a historical message.

4. The method of claim 2, further comprising:
detecting a user parameter, based on the first input, the second input or a third input;
wherein the recommendation score is further computed based on relevancy to the user parameter based on a distance between each of the one or more recommended second elements and the user parameter in a defined user parameter space.

5. The method of claim 4, wherein the first, second or third input representing the user parameter is obtained by at least one of:
a gesture input;
a facial expression input;
a text input;
an audio input; or
a force input.

6. The method of claim 1, further comprising:
displaying, via the user interface, one or more recommended first elements to include in the message, the one or more recommended first elements being ranked using a recommendation score that is computed based on relevancy to a context of the message.

7. The method of claim 6, wherein the context of the message is a user parameter of the message, the method further comprising:
detecting the user parameter of the message;
wherein the recommendation score is computed based on relevancy to the user parameter of the message based on a distance between each of the one or more recommended first elements and the user parameter in a defined user parameter space.

8. The method of claim 6, wherein the context of the message includes a prior element in a messaging session, and wherein the recommendation score is computed based on at least one of:
emotional relevancy to the prior element, wherein the emotional relevancy is computed based on a distance between the prior element and each of the one or more recommended first elements in a defined emotion space; or
statistical relevancy to the prior element, wherein the statistical relevancy is computed based on occurrence of each of the one or more recommended first elements together with the prior element in a historical message.

9. The method of claim 1, wherein the first element belonging to the first output modality and the at least one second element belonging to the second output modality is at least two different ones of:
a static graphic element;
an animation element;
an audio element; or
a haptic element.

10. The method of claim 1, wherein the device is one of:
a mobile communication device;
a laptop device;
a tablet device;
a wearable device;
an Internet of Things (IoT) device; or
a vehicular device.

11. The method of claim 1, wherein outputting the message comprises:
transmitting, to a receiving device, a communication of the message including the multimodal element.

12. The method of claim 11, wherein transmitting the communication of the message including the multimodal composition includes transmission of a set of one or more user parameters associated with the multimodal composition, wherein the one or more user parameters define how the multimodal composition causes the receiving device to generate output in at least one of the first and the second output modalities.

13. The method of claim 1, further comprising:
obtaining the first input and the second input via at least one user input.

14. A method at a device, the method comprising:
receiving a communication of a message including a multimodal composition, the multimodal composition being a combination of a first element belonging to a first output modality and at least one second element belonging to a second output modality, receipt of the multimodal composition including receipt of a set of one or more parameters associated with the multimodal composition;
detecting an input for interacting with the multimodal composition; and
generating a multimodal output in accordance with the detected input, the multimodal output being generated in accordance with the set of one or more parameters associated with the multimodal composition.

15. An electronic device comprising:
a memory storing instructions; and
a processing unit coupled to the memory;
wherein the processing unit is configured to execute the instructions to cause the device to:
obtain, via a user interface for generating a message, a first input indicating a first element belonging to a first output modality to include in the message;
obtain, via the user interface, a second input indicating at least one second element belonging to a second output modality to associate with the first element,
combine the first element and the at least one second element to generate a multimodal composition; and
output the message including the multimodal element.
